(19) United States
(12) Patent Application Publication
(10) Pub. No.: US 2005/0104831 A1
(43) Pub. Date: May 19, 2005

(54) TFT liquid crystal display driving method and TFT liquid crystal display driving module

(76) Inventor: Masafumi Hoshino, Chiba-shi (JP)

Correspondence Address: ADAMS & WILKS, 31ST FLOOR, 50 BROADWAY, NEW YORK, NY, 10004, US

(21) Appl. No.: 10/984,311

(22) Filed: Nov. 9, 2004

(30) Foreign Application Priority Data
Nov. 14, 2003 (JP) 2003-385010

(51) Int. Cl. G09G 3/36

(52) U.S. Cl. 345/92

(57) ABSTRACT

To provide a TFT liquid crystal display driving method for realizing low electric power consumption compared to line inversion driving and dot inversion driving by means of improving cross talk, brightness non-uniformity in a perpendicular direction, and flicker in frame inversion driving. Write scanning to the TFT liquid crystal display is performed at a speed equal to several times a normal speed, and a pause period is formed thereafter having a length equal to several times the length of the write period. Further, by maintaining a signal electrode waveform during the pause period at a constant gray scale level, the difference between a display pattern integrated over one frame period and the value of the waveform integrated over one frame period becomes relatively small. In addition, by setting memory in a standby mode during the pause period, and by slowing an electric power source booster circuit clock, the energy consumption of a TFT liquid crystal display driving module decreases.

### BACKGROUND OF THE INVENTION

1. Field of the Invention

The present invention relates to a TFT liquid crystal display driving method. In particular, the present invention relates to a TFT liquid crystal display driving method and to a TFT liquid crystal display driving module having low electric power consumption and little cross talk, and having a uniform brightness across the entire screen, without brightness non-uniformity.

2. Description of the Related Art

Liquid crystal active matrix display devices in which thin film transistors (TFTs) and liquid crystals are laminated to display images are widely used in personal computers, workstations, and the like since a high contrast ratio display can be achieved and a multicolor display is simply made. Further, the liquid crystal active matrix display devices have also come to be used in mobile telephones in recent years due to their low electric power consumption.

A TFT liquid crystal display driving method in which driver signals are converted into a.c. signals in order to lengthen the life time of liquid crystal is generally used. In frame inversion driving method in which inversion of the a.c. signal applied to the TFT liquid crystal is made for every frame, however, there are problems such as screen flicker, severe vertical cross talk, and occurrence of non-uniformity that possesses brightness gradients in perpendicular direction of the screen.

FIG. 2 shows a display example of cross talk that occurs in conventional frame inversion driving method, and FIG. 3 shows a waveform that is applied to signal electrodes of a column “a” and a column “b” of the display shown in FIG. 2 when cross talk occurs. Further, a broken line 33 is a waveform that is applied to opposing electrodes.

In FIG. 2 reference numeral 21 denotes a white portion, reference numeral 22 denotes a black portion, and reference numeral 23 denotes gray portion of intermediate level, which also constructs a background. A portion 24 of the column “a” which should display gray is taken as an example. An intermediate level electric potential is applied to pixels at a period 34 of the waveform “a” of FIG. 3. After receiving influence of signal electrodes at periods 35 and 31 of the waveform “a” during a later holding period, the intermediate level electric potential is again applied at a period 39. Accordingly, the gradation level of the portion 24 shifts toward the white side by the influence of the signal electrodes although the portion 24 should be gray with the same level as that of the background portion 23. The second example is a portion sandwiched between the white display portion 21s of the column “a”, which should be gray, to which an intermediate level electric potential is applied to pixels thereof at a period 36 of the waveform “a” of FIG. 3 and later receiving influence from signal electrodes at a period 37 and a period 310 of the waveform “a” during a later holding period, an intermediate electric potential is again applied at a period 311 of the waveform “a”. However, influence to shift toward the white side received at the period 37 and influence to shift toward the black side received at the period 310 cancel each other to result in no net shift in the gray scale level. The third example is the portion 25 of the column “a”, which should display gray, to which an intermediate electric potential is applied to pixels at a period 38 of the waveform “a” of FIG. 3. Influence from signal electrodes at a period 310 and a period 312 is then received during a later holding period, an intermediate level electric potential is again applied at a period 313. Influence toward the black side is received at both the periods 310 and 312, and the gray scale level thus shifts toward the black side. Similar phenomena occur in the column “b”.

Inflame inversion driving method the change ineffective value applied to the liquid crystal causes brightness difference since an electric potential applied to the pixel electrodes during a selected period is affected by the electric potential due to the waveform of the signal electrodes during a non-selected period. Furthermore, since the signal electrode waveform from selection to the end of the frame, and the signal electrode waveform from the beginning to selection in the next frame cancel each other, an upper portion and a lower portion of the panel thus receive opposite influences, and non-uniformity that possess brightness gradients along perpendicular direction develops.

To overcome these difficulties in TFT liquid crystal display driving method shortening the effective a.c. inversion period was proposed and are known as dot inversion driving and line inversion driving in which an inversion period of an a.c. signal applied to liquid crystals is switched at every pixel or every scanning line, respectively, (refer to JP 5-29916B, for example).

In these two driving methods, however, electric power consumption is larger than that of the frame inversion driving. Comparing the electric power consumption, line inversion driving consumes approximately three times as much as frame inversion driving and dot inversion driving consumes approximately six times as much as frame inversion driving.

### SUMMARY OF THE INVENTION

An object of the present invention is to provide a TFT liquid crystal display driving method having low electric power consumption compared to line inversion driving and dot inversion driving by means of improving cross talk, non-uniform brightness in a perpendicular direction, and flicker in frame inversion driving.

The present invention solves the problems described above by forming a scanning period and a pause period within one frame period, setting the pause period to be longer than the scanning period, and utilizing the fact that the extent of influence of the pause period is proportional to the difference between the value of a signal electrode waveform integrated from one selection point to the next selection point, and the value of a background portion integrated over the same period. Specifically, write scanning to the TFT liquid crystal panel is performed at a speed equal to several times a normal speed, and the pause period is formed thereafter having a length equal to several times the length of the write period. Further, by maintaining the signal electrode waveform during the pause period at a constant gray scale level, the difference between a display pattern integrated over one frame period and the value of the waveform integrated over one frame period becomes relatively small. In addition, by placing memory in a standby mode during the pause period, and by delaying an electric power source booster circuit clock, the energy consumption of a TFT liquid crystal display driving module decreases.

### BRIEF DESCRIPTION OF THE DRAWINGS

In the accompanying drawings:

FIG. 1 is a diagram that shows examples of signal electrode waveforms of the present invention;

FIG. 2 is a diagram that shows a frame inversion driving display example;

FIG. 3 is a diagram that shows signal electrode waveforms for conventional frame inversion driving; and

FIG. 4 is a diagram that shows a first row of a signal electrode waveform.

### DETAILED DESCRIPTION OF THE PREFERRED EMBODIMENTS

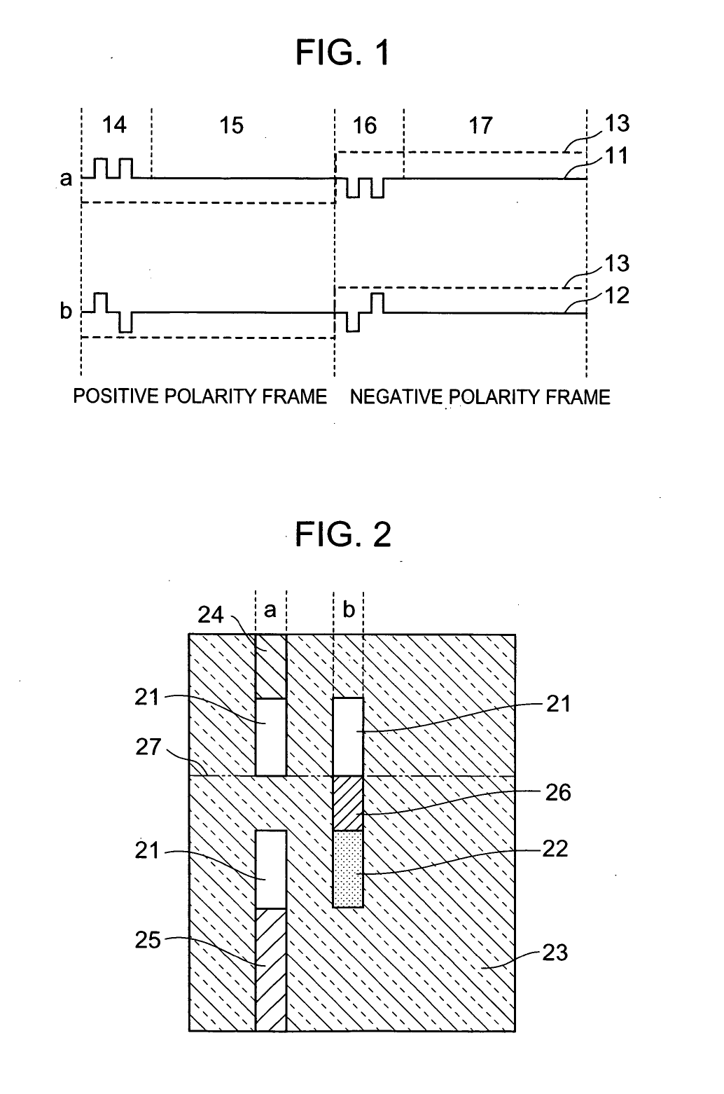

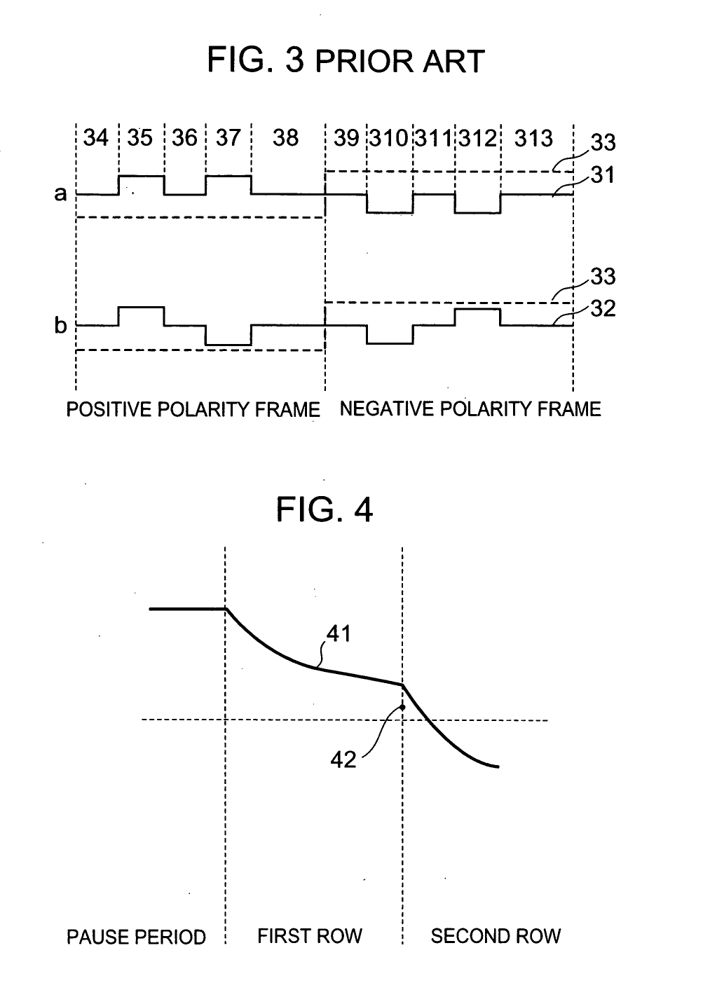

FIG. 1 shows signal electrode waveforms when-displaying a display pattern of FIG. 2 by frame driving method of the present invention.

Referring to FIG. 1, in this embodiment the display pattern is sent to a TFT liquid crystal panel by scanning during a positive polarity frame period 14, and there is a pause during a subsequent period 15 where all scanning electrodes are placed in a non-selected state. Write is performed similarly during a period 16 in a negative polarity frame, and a period 17 is formed as a pause period. The write speed here is set to four times the normal write speed, and the period 15 is set to have three times longer the time as that of the period 14. Signal electrodes in all rows are maintained at an intermediate level during the pause periods of the periods 15 and 17. A broken line 13 is a waveform that is applied to opposing electrodes. Cross talk of the portions 24, 25, and 26 of FIG. 2, non-uniformity that possess a brightness gradient in a perpendicular direction of a screen, and flicker, all of which occur during conventional frame inversion driving, can thus be reduced. Further, the effects described above can also be obtained when the pause period is set to be twice as long as the scanning period although the pause period is set to be three times as long as the scanning period in this embodiment.

Furthermore, by setting memory in a standby mode and slowing clock of a booster circuit in power supply circuit during the pause period, it becomes possible to reduce the electric power consumption of a TFT liquid crystal display module. With a TFT liquid crystal display module having a panel size of 30×35 mm and 128×160 pixels, at a frame frequency of 70 Hz, the current consumption is from 4 to 5 mA with line inversion drive, but from 2 to 2.2 mA with the driving method of the present invention.

Next, similar effects can also be obtained for cases when the voltage applied to the signal electrodes during the pause period is a black level. The pause period is formed to reduce the influence on the display quality from surrounding pixel electrodes as much as possible. The voltage applied to all of the signal electrodes may have any level, provided that the level is constant.

Further, since the voltage value during the pause period and the voltage value applied to a first row always differ, a phenomenon in which current supply can not be in time due to electric current variance caused by the transition from the pause period to the subsequent frame occurs. FIG. 4 shows an actual signal electrode waveform measured against a voltage 42 which should be applied to the TFT liquid crystal panel. The voltage waveform 41 shows that the correct voltage cannot be applied. With the present invention, a period of one selection portion is formed immediately prior to write of the first row, data for the first row is output in advance, and the output data is set into the signal electrodes over a long period of time during the first row only, thus solving the problem described above.

In addition, the display pattern is written into the TFT liquid crystal panel at high speed with the present invention, and consequently the driver capabilities of a driver IC connected to the signal electrodes determine the display quality. Accordingly, with a driver IC that supplies a gray scale voltage generated at one location to signal electrodes by switching a switching transistor, the supply during high speed write is not in time due to current variation and the correct voltage value cannot be applied when the next scanning electrode is selected. For example, with the display pattern of FIG. 2, a transverse line develops in a row 27 that is lined up next to the portion 21. When the frame inversion driving method of the present invention is used, a TFT liquid crystal display module having good quality, where the display pattern does not exert any influence on the next row in the transverse direction over the entire pixel portion, can thus be provided by using a driver IC having mutually independent amplifier structure in output stage of the signal electrode side for driving.

According to the TFT liquid crystal display driving method of the present invention, it becomes possible to provide a TFT liquid crystal display driving module in which cross talk, brightness non-uniformity in a perpendicular direction and flicker are suppressed and the power consumption is reduced in the frame driving.

1. A method of driving a TFT liquid crystal display comprising a plurality of signal lines and a plurality of scanning lines that intersect one another, and a pixel electrode and a switching element in the vicinity of each intersecting portion, the method comprising:
forming a scanning period and a pause period within one frame period;
wherein the pause period is longer than the scanning period.

2. A method of driving a TFT liquid crystal display according to claim 1, wherein the polarity of a driving waveform applied to a liquid crystal layer reverses at every frame.

3. A method of driving a TFT liquid crystal display according to claim 1, wherein electric potentials of the scanning lines are fixed to constant values during the pause period.

4. A method of driving a TFT liquid crystal display according to claim 1, wherein the number of pause periods is equal to or greater than twice the number of scanning periods.

5. A method of driving a TFT liquid crystal display according to claim 1, wherein a fixed period is established between the end of the pause period and the start of the subsequent scanning period, and wherein a first row of data is sent to the signal lines during the fixed period.

6. A method of driving a TFT liquid crystal display according to claim 1, wherein during the pause period, memory is set to a standby mode, and a clock of a booster circuit of a power supply is slowed.

7. A TFT liquid crystal display driving module that uses the method of driving a TFT liquid crystal panel according to claim 1.

8. A TFT liquid crystal panel driver module according to claim 7, wherein output stages connected to the signal lines comprise mutually independent amplifiers.
